(19) United States
(12) Patent Application Publication
(10) Pub. No.: US 2025/0188266 A1
(43) Pub. Date: Jun. 12, 2025

(54) MODIFIED PHENOLIC RESINS FOR MAKING COMPOSITE PRODUCTS

(71) Applicant: BAKELITE UK HOLDING LTD., Penarth (GB)

(72) Inventors: Christopher Langley, Louisville, KY (US); Kimberly Goodwin, Georgetown, IN (US); J.V. Kingston, Louisville, KY (US)

(21) Appl. No.: 18/844,404

(22) PCT Filed: Mar. 9, 2023
(86) PCT No.: PCT/EP2023/056017

§ 371 Date: Sep. 6, 2024

Related U.S. Application Data
(60) Provisional application No. 63/318,061, filed on Mar. 9, 2022.

(51) Int. Cl. C08L 61/34; B01J 20/18; B01J 20/28; C08G 14/06; C08K 7/26

(52) U.S. Cl. CPC C08L 61/34; B01J 20/18; B01J 20/2808; B01J 20/28083; C08G 14/06; C08K 7/26

(57) ABSTRACT

A binder composition and method for making same. The binder composition can include 50-93 wt % phenolic-aldehyde novolac resin, 5-15 wt % hexamine, 0-10 wt % other additives and 2-30 wt % of at least one sorbent, based on the total weight of the resin. The binder composition is particularly useful for wood products.

### CROSS-REFERENCE TO RELATED APPLICATIONS

This application claims priority to U.S. Provisional Patent Application having Ser. No. 63/318,061, filed on Mar. 9, 2022. The entirety of which is incorporated by reference herein.

### FIELD OF THE INVENTION

Embodiments of the present invention generally relate to phenolic resins.

### BACKGROUND

Phenolic resins are well-known adhesives that can be used for making laminated products, molded products, amongst other things. Phenolic resins, novolacs in particular, also have a wide variety of uses, such as refractories, friction materials, abrasives, felt bonding and as curing agents for epoxies. Superior adhesion, high thermal and chemical resistance, and flame-smoke-toxicity (FST) properties are some of the properties that novolac resins provide that make them suitable in such applications.

A traditional problem facing these industries, however, is volatile emissions produced during the cure of the phenolic resin. These emissions can cause voids and defects in the final articles where phenolic resin is the binder material. This is a leading cause of scrap generation across multiple markets. These volatile emissions can also cause damage to equipment and molding surfaces, which routinely requires downtime for cleaning and resurfacing due to the chemical corrosiveness of the gases produced and interference of the emitted gases with other components during the formation of the molded article.

Novolacs, for example, are often cross-linked and known to give off ammonia gas when cured with amine containing hardeners. For instance, novolac powder with hexamethylenetetramine (“hexamine”) is widely used in wood molding applications. The novolac powder and hexamine is mixed with wood particles, pressed and cured at high temperature, rendering a stable molded part that exhibits high strength, minimal water absorption, and is paintable. During the curing process, hexamine decomposes into ammonia and formaldehyde. The formaldehyde acts to crosslink the novolac polymer into the final product, which will hold shape and display chemical resistance. The ammonia is released as a gas, which can be odorous and produce toxic VOCs.

Frequently, it is required for parts to be post-baked after curing to fully remove the ammonia from the product and prevent unwanted odors from being slowly emitted from the final product. Such post-baking process adds additional cycle time and energy spent for the overall manufacturing process.

In addition, the ammonia released from this process can have detrimental effects on the molding equipment. Particularly, in molded wood products, the released ammonia gas can cause sticking of the molded part to the mold. Sticking requires manual remediation to remove and clean the molds.

Attempts have been made to lower the amount of hexamine present in the formulation to avoid these deleterious consequences of the released ammonia. This solution, however, reduces the crosslink density of the novolac resin and thus reduces the strength of the final product. Other attempts to remove ammonia have tried modifying the heat processing cycles by opening and closing the molds to release trapped ammonia and other gases, effectively lengthening the processing times and energy for making the molded parts.

There is still a need, therefore, for improved resins and methods for using same in the manufacture of molded composite products.

### SUMMARY

Binder compositions and methods for making same are provided herein. In at least one embodiment, the binder can include 50-93 wt % of a phenolic-aldehyde novolac resin, 5-15 wt % hexamine, 0-10 wt % other additives and 2-30 wt % of at least one sorbent, based on the total weight of the resin. The binder composition is particularly useful for wood products, and more particularly molded wood products.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a side view of three plaques that were produced, showing the imperfections due to trapped volatiles: Top Sample: 2854-6-1; Middle Sample: 2854-6-2; and Bottom Sample: 2854-6-3.

FIG. 2 shows visual staining on Q plates after pressing cycles. Top row: 2854-1-1, 2854-1-2-1, and 2854-1-3-1. Bottom row: 2854-1-4-1, 2854-1-5-1, and 2854-1-6-1. Note: The “B” on each plate indicates the bottom plate used for the testing and evaluation of staining.

### DETAILED DESCRIPTION

It has been surprisingly and unexpectedly discovered that the addition of a zeolite or other suitable solid sorbent to a phenol-aldehyde-hexamine resin composition provides a significant reduction (i.e. over 21%) of ammonia that is produced during the curing process of the resin, without reducing the amount of hexamine in the resin.

The resin can be produced via any suitable process. For example, one or more phenolic compounds, one or more aldehyde compounds, and, optionally, one or more catalysts can be directed, charged, or otherwise introduced to a reaction vessel to provide a reaction mixture therein. The reaction mixture can be agitated. For example, if a solvent is also present in the reaction vessel, the reaction mixture can be agitated to improve and/or maintain a homogeneous or substantially homogenous distribution of the reactants in the solvent or a homogeneous or substantially homogenous distribution of the solvent in the reaction mixture. The components of the reaction mixture can be combined within one or more mixers. The mixer can be or include any device, system, or combination of device(s) and/or system(s) capable of batch, intermittent, and/or continuous mixing, blending, contacting, or the otherwise combining of two or more components. Illustrative mixers can include, but are not limited to, mechanical mixer agitation, ejectors, static mixers, mechanical/power mixers, shear mixers, sonic mixers, vibration mixing, e.g., movement of the mixer itself, or any mixture thereof. The mixer can include one or more heating jackets, heating coils, internal heating elements, cooling jackets, cooling coils, internal cooling elements, or the like, to regulate the temperature therein. The mixer can be an open vessel or a closed vessel. The components of the reaction mixture can be combined within the mixer under a vacuum, at atmospheric pressure, or at pressures greater than atmospheric pressure. The sorbent can be added to the phenol-aldehyde composition before or after the hexamine addition.

The phenolic resin can have a molar ratio of the aldehyde component(s) or compound(s) to phenolic component(s) or compounds of less than 1:1. For example, the molar ratio of the aldehyde component(s) or compound(s) to phenolic component(s) or compounds can be about 0.2:1, about 0.3:1, about 0.4:1, about 0.5:1, about 0.6:1, about 0.7:1, about 0.8:1, or about 0.9:1. The phenolic resin can also have a molar ratio of aldehyde to phenol of about 0.5:1 to about 0.95:1. The molar ratio of aldehyde to phenol can also range from a low of about 0.2:1, about 0.3:1, or about 0.4:1 to a high of about 0.7:1, about 0.8:1, or about 0.95:1.

The one or more catalysts can include, but is not limited to, one or more acid catalysts. Suitable acid catalysts include hydrochloric acid, sulfuric acid, phosphoric acid, oxalic acid, sulfonic acid, sulfamido acids, haloacetic acids, and combinations thereof.

The reaction mixture can have a catalyst concentration that ranges from a low of about 0.2 wt %, about 1 wt %, or about 2 wt %, to a high of about 7 wt %, about 12 wt %, or about 20 wt %, based on the combined weight of the phenol, formaldehyde, and catalyst. For example, the reaction mixture can have a catalyst concentration of about 0.2 wt % to about 1 wt %, about 1 wt % to about 5 wt %, about 5 wt % to about 10 wt %, about 8 wt % to about 15 wt %, about 12 wt % to about 20 wt %, based on the combined weight of the phenol, formaldehyde, and catalyst. In another example, at least about 0.001 mol of catalyst per mol of the phenolic component can be used. In another example, the reaction mixture can have concentration of catalyst of about 0.02 mol to about 1 mol per mol of the phenolic component. The catalyst can be added initially to the reaction mixture at once or the catalyst can be added incrementally in two or more additions or continuously over time.

In the presence of the one or more acid catalysts, the one or more phenolic components and the one or more aldehyde components can be reacted at a temperature of about 20° C., about 25° C., about 30° C., about 35° C., or about 40° C. to about 50° C., about 55° C., about 60° C., about 65° C., about 70° C., about 75° C., about 80° C., about 85° C., about 90° C., about 95° C., or about 100° C., or about 105° C.

The phenolic component can include one or more phenolic compounds. The one or more phenolic compounds can be monohydroxyaromatic and/or dihydroxyaromatic compounds. For example, the phenolic compound can be phenol, one or more substituted phenol compounds, one or more unsubstituted phenol compounds, or any combination or mixture of substituted and/or unsubstituted phenol compounds. For example, the phenolic component can be or include phenol itself (monohydroxybenzene). Illustrative substituted phenolic compounds can include, but are not limited to, alkyl-substituted phenols such as, cresols, xylenols and other substituted monohydroxybenzene compounds; cycloalkyl-substituted phenols such as cyclohexyl phenol; alkenyl-substituted phenols; aryl-substituted phenols such as p-phenyl phenol; alkoxy-substituted phenols such as 3,5-dimethyoxyphenol; aryloxy phenols such as p-phenoxy phenol; and halogen-substituted phenols such as p-chlorophenol. Dihydric phenols or dihydroxyaromatic compounds such as catechol, resorcinol, hydroquinone, bisphenol A and bisphenol F also can also be used. For example, the phenolic component can be or include, but is not limited to, resorcinol, phenol, catechol, hydroquinone, naphthol, pyrogallol, 5-methylresorcinol, 5-ethylresorcinol, 5-propylresorcinol, 4-methylresorcinol, 4-ethylresorcinol, 4-propylresorcinol, resorcinol monobenzoate, resorcinol monosinate, resorcinol diphenyl ether, resorcinol monomethyl ether, resorcinol monoacetate, resorcinol dimethyl ether, phloroglucinol, benzoylresorcinol, resorcinol rosinate, alkyl substituted resorcinol, aralkyl substituted resorcinol, 2-methylresorcinol, phloroglucinol, 1,2,4-benzenetriol, 3,5-dihydroxybenzaldehyde, 2,4-dihydroxybenzaldehyde, 4-ethylresorcinol, 2,5-dimethylresorcinol, 5-methylbenzene-1,2,3-triol, 3,5-dihydroxybenzyl alcohol, 2,4,6-trihydroxytoluene, 4-chlororesorcinol, 2′,6′-dihydroxyacetophenone, 2′,4′-dihydroxyacetophenone, 3′,5′-dihydroxyacetophenone, 2,4,5-trihydroxybenzaldehyde, 2,3,4-trihydroxybenzaldehyde, 2,4,6-trihydroxybenzaldehyde, 3,5-dihydroxybenzoic acid, 2,4-dihydroxybenzoic acid, 2,6-dihydroxybenzoic acid, 1,3-dihydroxynaphthalene, 2′,4′-dihydroxypropiophenone, 2′,4′-dihydroxy-6′-methylacetophenone, 1-(2,6-dihydroxy-3-methylphenyl) ethanone, 3-methyl 3,5-dihydroxybenzoate, methyl 2,4-dihydroxybenzoate, gallacetophenone, 2,4-dihydroxy-3-methylbenzoic acid, 2,6-dihydroxy-4-methylbenzoic acid, methyl 2,6-dihydroxybenzoate, 2-methyl-4-nitroresorcinol, 2,4,5-trihydroxybenzoic acid, 3,4,5-trihydroxybenzoic acid, 2,3,4-trihydroxybenzoic acid, 2,4,6-trihydroxybenzoic acid, 2-nitrophloroglucinol, or any mixture thereof. The phenolic component can include any combination of two or more phenol compounds combined with one another and/or added independent of one another to the reaction mixture.

The aldehyde component can include one or more aldehyde compounds. The aldehyde compound can be or can include one or more substituted aldehyde compounds, one or more unsubstituted aldehyde compounds, or any mixture of substituted and/or unsubstituted aldehyde compounds. Suitable aldehyde compounds can include, but are not limited to, aldehydes having the chemical formula R′CHO, where R′ is hydrogen or a hydrocarbyl group. Suitable hydrocarbyl groups can include 1 to 8 carbon atoms. Suitable aldehyde compounds can also include the so-called masked aldehydes or aldehyde equivalents, such as acetals or hemiacetals. Illustrative aldehyde compounds can be, but are not limited to, formaldehyde, paraformaldehyde, acetaldehyde, propionaldehyde, butyraldehyde, furfuraldehyde, benzaldehyde, or any mixture thereof. Still other suitable formaldehyde compounds can be formaldehyde present in a prepolymer or pre-condensate such as urea-formaldehyde precondensate (UFC).

It will be appreciated by one skilled in the art that the term “aldehyde” in the above context of the condensation of a hydroxyaromatic monomer with an aldehyde can further include aldehyde precursors, also referred to as aldehyde sources or donors, i.e., compounds which can generate aldehyde under the conditions of use, or alternately can provide substantially the same reactive radical expected from the condensation of the hydroxyaromatic monomer with the corresponding aldehyde. Suitable aldehyde precursors include for example, but are not limited to, compounds such as formalin, para-formaldehyde (“paraform”), alpha-polyoxymethylene, hexamethylenetetramine (“hexamine”), oxazolidines, 1,3,5-trioxacyclohexane, and the like.

The aldehyde compound can also be or can include, but is not limited to, one or more multifunctional aldehyde compounds. As used herein, the terms “multifunctional aldehyde compound” and “multifunctional aldehyde” are used interchangeably and refer to compounds having at least two functional groups, with at least one of the functional groups being an aldehyde group. For example, the multifunctional aldehyde can include two or more aldehyde functional groups. In another example, the multifunctional aldehyde can include at least one aldehyde functional group and at least one functional group other than an aldehyde functional group. As used herein, the term “functional group” refers to reactive groups in the multifunctional aldehyde compound and can include, but is not limited to, aldehyde groups, carboxylic acid groups, ester groups, amide groups, imine groups, epoxide groups, aziridine groups, azetidinium groups, and hydroxyl groups.

The multifunctional aldehyde compound can include two or more carbon atoms and have two or more aldehyde functional groups. For example, the multifunctional aldehyde compound can include two, three, four, five, six, or more carbon atoms and have two or more aldehyde functional groups. The multifunctional aldehyde compound can include two or more carbon atoms and have at least one aldehyde functional group and at least one functional group other than an aldehyde group such as a carboxylic acid group, an ester group, an amide group, an imine groups, an epoxide group, an aziridine group, an azetidinium group, and/or a hydroxyl group. For example, the multifunctional aldehyde compound can include two, three, four, five, six, or more carbon atoms and have at least one aldehyde functional group and at least one functional group other than an aldehyde group such as a carboxylic acid group, an ester group, an amide group, an imine groups, an epoxide group, an aziridine group, an azetidinium group, and/or a hydroxyl group.

Suitable bifunctional or difunctional aldehyde compounds that include three or more carbon atoms and have two aldehyde functional groups (—CHO) can be represented by the following chemical formula:

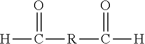

where R can be a divalent aliphatic, cycloaliphatic, aromatic, or heterocyclic group having 1 carbon atom to 12 carbon atoms. Illustrative multi-functional aldehydes can include, but are not limited to, malondialdehyde, succindialdehyde, glutaraldehyde, 2-hydroxyglutaraldehyde, β-methylglutaraldehyde, adipaldehyde, pimelaldehyde, suberaldehyde, malealdehyde, fumaraldehyde, sebacaldehyde, phthalaldehyde, isophthalaldehyde, terephthalaldehyde, ring-substituted aromatic aldehydes, or any combination or mixture thereof. A suitable bifunctional or difunctional aldehyde that includes two carbon atoms and has two aldehyde functional groups is glyoxal.

Illustrative multifunctional aldehyde compounds that include an aldehyde group and a functional group other than an aldehyde group can include, but are not limited to, glyoxylic acid, glyoxylic acid esters, glyoxylic acid amides, 5-(hydroxymethyl) furfural, or any combination or mixture thereof. The aldehyde group in the multifunctional aldehyde compound can exist in other forms, e.g., as a hydrate. As such, any form or derivative of a particular multifunctional aldehyde compound can be used to prepare the resin compositions that are discussed and described herein. For example, in the context of glyoxylic acid, glyoxylic acid, glyoxylic acid monohydrate, and/or glyoxylate can be used to produce the phenolic resin.

If the aldehyde component is formaldehyde, a formaldehyde scavenger can be used to reduce the amount of free formaldehyde in the resin. Illustrative formaldehyde scavengers can include, but are not limited to, urea, amines, ammonia, and alkanolamines.

If the aldehyde component is formaldehyde, the phenolic resin can have an amount of free formaldehyde of about 0.001 wt % and about 6 wt %. For example, the phenolic resin can have a concentration of free formaldehyde of about 0.03 wt % to about 0.13 wt %, about 0.1 wt %, about 0.5 wt %, about 1 wt %, or about 2 wt % to about 3 wt %, about 5 wt %, or about 6 wt %, based on the total weight of the phenolic resin. In another example, the phenolic resin can have a concentration of free formaldehyde of less than 3 wt %, less than 2 wt %, less than 1 wt %, less than 0.5 wt %, less than 0.3 wt %, less than 0.2 wt %, less than 0.15 wt %, or less than 0.1 wt %, based on the total weight of the phenolic resin.

The phenolic resin can have a concentration of free phenol of about 0.1 wt %, about 0.5 wt %, about 1 wt %, or about 2 wt % to about 5 wt %, about 10 wt %, or about 15 wt %, based on the total weight of the phenolic resin. The phenolic resin can have an amount of free phenol of about 0.1 wt % and about 6 wt %, about 2 wt % and about 8 wt %, about 5 wt % and about 12 wt %, or about 7 wt % and about 15 wt %, based on the total weight of the phenolic resin.

The phenolic resin can have a weight average molecular weight (M_{w}) of about 200, about 300, or about 400 to about 900, about 1,500, or about 40,000.

The phenolic resin can have a number average molecular weight (Mₙ) of about 200, about 300, or about 400 to about 900, about 1,500, or about 40,000.

The phenolic resin can have a z-average molecular weight (M_{z}) of about 200, about 300, or about 400 to about 900, about 1,500, or about 40,000. M_{w}, Mₙ, and M_{z} can be measured using gel permeation chromatography (GPC), also known as size exclusion chromatography (SEC).

A variety of procedures can be used for condensing the hydroxyaromatic compound and aldehyde components to form a thermoplastic solid composition. Condensation of the one or more hydroxyaromatic compounds, aldehydes and catalyst can be carried out by a melt condensation process or by a solution condensation process. Process controls such as staged monomer addition, staged catalyst addition, pH control, amine modification and the like are useful in maintaining properties of the resin. An illustrative process that can be used to produce a phenolic resin as described herein is further described in U.S. Pat. No. 6,706,845.

Suitable phenolic resins can include, but are not limited to, phenol-formaldehyde resins, resorcinol formaldehyde resins, and phenol-resorcinol-formaldehyde resin, bisphenol A modified resin, bisphenyl F modified resin, and t-butyl phenol modified resin.

A composite product can be made by contacting one or more substrates with the resin composition, and at least partially curing the resin composition to produce the composite product. Suitable substrates include lignocellulosic materials, e.g., wood products. Lignocellulosic materials are cellulosic materials and can be derived from a large number of natural sources including wood. Other suitable sources include sugar cane bagasse, straw, cornstalks, and other waste vegetable matter. In a particular embodiment, the lignocellulosic materials can be derived from various species of wood in the form of wood fibers, chips, shavings, flakes, particles, veneers, and flours. The resin composition provided herein can be used with a variety of soft and hard woods, such as, for example, Douglas Fir, White Fir, Hemlock, Larch, Southern Yellow Pine, Ponderosa Pine, Spruce, Black Pine, combinations comprising at least one of the foregoing, and the like. Specifically, Douglas Fir, Ponderosa Pine, and Southern Yellow Pine, are useful with the resin composition provided herein. The resin composition can be applied to the wood particles by blending the particles with the resin composition while the particles are tumbled or agitated in a blender or equivalent apparatus.

One or more acids, heat, catalysts, and/or pressure can be added, mixed, blended, or otherwise combined with or transferred to the resin composition prior to, during, and/or after application of the resin composition to the wood particles to provide a composite. The acid, heat, and/or pressure can initiate or start and/or accelerate curing of the resin. In certain embodiments, one or more curing accelerators can be added to the resin composition to reduce cure time. The amount of accelerator that can be added to the resin composition to initiate or start curing of the resin composition can be about 0.01 wt %, about 0.5 wt %, about 0.8 wt %, or about 1 wt % to about 5 wt %, based on the combined weight of the resin composition and the additive. For example, the amount of the accelerator additive that can be added to the resin composition to initiate or start curing of the resin can range from a low of about 0.1 wt %, 0.3 wt % or 0.5 wt % to a high of about 1.0 wt %, 3.0 wt %, or 5.0 wt %, based on the combined weight of the resin composition and the catalyst.

The wood composite can contain about 2.0 wt % to about 40 wt % of the resin composition, based on the total weight of the wood composite. The amount of the resin composition in the wood composite can also range from a low of about 2.0 wt %, 5 wt % or 10 wt % to a high of about 20 wt %, 30 wt % or 40 wt %, based on the total weight of the wood composite. The amount of the resin composition in the wood composite can also range from a low of about 3.5 wt %, 7.5 wt % or 11.5 wt % to a high of about 15.0 wt %, 17.5 wt % or 27.5 wt %, based on the total weight of the wood composite.

Suitable bases that can be used to accelerate cure in the resin composition can include, but are not limited to, organic bases, inorganic bases, or any mixture thereof. Illustrative inorganic bases can include, but are not limited to, magnesium oxide, magnesium hydroxide, calcium oxide, calcium hydroxide, lime, hexamethylenediamine, lithium hydroxide. Suitable acids that can be used to accelerate cure in the resin composition can include but are not limited to adipic acid, fumaric acid, salicylic acid, and oxalic acid.

As used herein, the terms “curing,” “cured,” and similar terms are intended to refer to the structural and/or morphological change that occurs in the resin composition as it is cured to cause covalent chemical reaction (crosslinking), ionic interaction or clustering, improved adhesion to the substrate, phase transformation or inversion, and/or hydrogen bonding. As used herein, the phrases “at least partially cure,” “at least partially cured,” and similar terms are intended to refer to a resin composition that has undergone at least some covalent chemical reaction (crosslinking), ionic interaction or clustering, improved adhesion to the substrate, phase transformation or inversion, and/or hydrogen bonding, but can also be capable of undergoing additional covalent chemical reaction (crosslinking), ionic interaction or clustering, improved adhesion to the substrate, phase transformation or inversion, and/or hydrogen bonding.

Any suitable curing technique can be used to cure the resin compositions provided herein. For example, a heat-curing technique can be used by heating the resin composition to a temperature of between about 100° C. and about 200° C., more preferably to between about 120° C. and about 180° C. for a period of about 5 to about 120 minutes, more preferably between about 30 to about 60 minutes.

Prior to curing or during the curing step, one or more suitable mold release agents can be added to the resin composition. Suitable mold release agents can include but are not limited to calcium stearate, zinc stearate, ethylene bis-stearyl amide, methylene stearyl amide, oxystearyl amide, stearyl amide, polyethylene wax, carnauba wax, Montan wax, paraffin wax, polyethylene wax, silicone compounds, and linoleyl amide. In some embodiments, for example, the mold-release agent can include a surfactant, such as, for example, calcium stearate.

The mold release agent can be present in the composition in any suitable amount. For example, in some embodiments, the mold release agent can be present in the composition in an amount of about 0.01 wt % to about 20 wt %, based on the total weight of the composition. In some embodiments, for example, the mold release agent can be present in the composition in an amount ranging for a low of about 0.01 wt %, 1.0 wt %, or 4.0 wt % to a high of about 10 wt %, 15 wt %, or 20 wt %, based on the total weight of the composition.

If the resin composition includes one or more additional additives, the amount of each additive can be from a low of about 0.001 wt %, about 0.01 wt %, about 0.1 wt %, about 1 wt %, or about 5 wt % to a high of 20 wt %, about 30 wt %, about 40 wt %, or about 50 wt %, based on the total weight of the composition. For example, if the resin composition includes one or more additional additives, the amount of each additive can about 0.01 wt % to about 5 wt %, about 1 wt % to about 10 wt %, about 5 wt % to about 40 wt %, about 0.01 wt % to about 50 wt %, about 2 w % to about 20 wt %, about 15 wt % to about 45 wt %, or about 1 wt % to about 15 wt %, based on the total weight of the composition.

Despite the presence of a mold release agent, when hexamine is used in the manufacture of the resin, the production of ammonia is expected. But it is not expected and has only recently been discovered that ammonia stains the molding equipment used to make molded wood products that contain the resin compositions, including those resins described herein. Such stains, in turn, cause the molded products to stick to their molds, causing defects in the product, reduced run times, and wasted downtime for additional cleaning and maintenance.

Another objective of the present invention addresses issues caused by ammonia emissions and air treatment ventilation for making composite products. The Environmental Protection Agency (EPA) has growing concerns regarding ammonia contamination of water and its contribution as a fine particulate matter precursor. Thus, processing ventilation air treatment prior to atmospheric release or recycling to the process puts an energy load on production. On top of the air processing, short bursts of mold openings and closings to release the volatiles increases the cycle time per part. The amount of ammonia released in turn, reduces the efficiency of production through both energy consumption and cycle time.

To address these and other problems caused by the presence of ammonia, a solid sorbent material can be added to the resin precursor and/or resin product to capture ammonia molecules that are formed during the resin curing process. By “solid sorbent material” it is meant, a diverse range of porous, solid-phase materials, including microporous zeolites and molecular sieves, activated carbon, and other metal-organic frameworks can be used to adsorb, absorb or otherwise trap the ammonia. Preferred sorbents include zeolites and molecular sieves. Zeolites include but are not limited to natural and synthetic hydrated aluminosilicates of alkaline and alkaline-earth metals. These are crystalline inorganic polymers with [SiO4] and [AlO4] tetrahedra that form a porous substrate. Natural zeolites can include: clinoptilolite, heulandite, stilbite, natrolite, analcime, chabazite, gismondine, phillipsite, levynite, mordenite, andersite, erionite, scolecite, ferrierite, laumonite. Synthetic zeolites include but are not limited to: Linde Type A (LTA), Linde Types X and Y, Silicalite-1, ZSM-5, Linde Type B, MCM-41, and other synthetic aluminosilicate molecular sieves. A preferred zeolite is clinoptilolite.

Silica gels could also be used. The sorbent should have a pore size suitable for adsorbing ammonia. Ammonia has an effective radius of about 3.6 Å, thus a suitable sorbent should have a pore size of greater than about 3.6 Å (e.g., a pore size of about 4 Å), but smaller than the other components that are not to be trapped.

For example, the sorbent could have an average pore size of about 2 Å to about 20 Å. In some embodiments, for example, the sorbent can have an average pore size of about 3 Å to about 10 Å, or about 3 Å to about 12 Å. In some embodiments, the sorbent can have an average pore size of about 4 Å to about 10 Å, for example about 4 Å to about 8 Å, or about 4 Å to about 6 Å. In some embodiments, the sorbent can have an average pore size of about 6 Å to about 10 Å. Pore size generally measured by nitrogen adsorption at 77 K utilizing density functional theory equations.

The amount of sorbent added to the reaction mixture or post condensation resin is important. The amount of sorbent can be about 1 wt % to 30 wt %, based on the total weight of the phenolic components and/or the total weight of the resin composition. The amount of sorbent can also range from a low of about 1 wt %, 2 wt %, 3 wt %, or 5 wt % to a high of about 10 wt %, 20 wt % or 30 wt %, based on the total weight of the phenolic components and/or the total weight of the resin composition. The amount of sorbent also can range from a low of about 1 wt %, 2 wt %, 3 wt %, or 5 wt % to a high of about 10 wt %, 20 wt % or 30 wt %, based on the total weight of the phenolic components and/or the total weight of the resin composition. A weight ratio of the sorbent to the hexamine in the resin composition can be about 1:0.5; about 1:0.6; about 1:0.7; about 1:0.8; about 1:0.9; about 1:1; about 1:0.55; about 1:0.65; about 1:0.75; about 1:0.6; 1:0.85; or about 1:0.95.

According to the invention a binder composition is claimed comprising:
50-93 wt % of a phenolic-aldehyde novolac resin; 5-15 wt % hexamine; and 2-30 wt % of at least one sorbent, based on the total weight of the resin.

Furthermore according the invention a cured resin composition is claimed, comprising:
50-93 wt % of a phenolic-aldehyde novolac resin; 5-15 wt % hexamine; and 2-30 wt % of at least one sorbent, based on the total weight of the resin composition, wherein the cured resin composition has a glass plate flow at 125° C. of 10 mm to 200 mm; a modulus of rupture (MOR), as measured by ASTM D790-03, of about 40 to about 150 MPa; a maximum flexure stress (modulus of elasticity) of about 5.0 to 8.0 GPa; and a % Char residue at 1,000° C. in nitrogen of about 30 to about 75%, as measured by Thermogravimetric Analysis (TGA).

In order to provide a better understanding of the foregoing discussion, the following non-limiting examples are offered. Although the examples can be directed to specific embodiments, they are not to be viewed as limiting the invention in any specific respect. All parts, proportions, and percentages are by weight unless otherwise indicated.

### Examples

A plant sample of a commercial grade solid novolac-hexamine composition lot #(LK1LE7778) (“Resin 1”) was modified with a clinoptilolite zeolite from IdaOre or limestone from Old Castle Mineral CastleCarb 6 (dolomitic limestone) and evaluated for off-gassing of ammonia. Resin 1 was a mixture of solid novolac resin and granular hexamine that had been pulverized in a grinder until 96.5 to 99.5%, by volume, of all the particles are less than or equal to 74 microns and where the hexamine is about 8% and the novolac is about 92% of the total weight of the composition. To incorporate the inorganic material, such as zeolite and/or limestone, into the resin, a mixture of the resin and the inorganic was charged to the mill, ground for 10 seconds, paused 10 seconds, ground 10 seconds, paused 10 seconds, the top of mill was tapped several times with a wood spatula handle, ground 10 seconds, and the sample was removed from the mill.

Table 1 shows the composition of three samples that were evaluated for ammonia emissions using the modified Resin 1 and Table 2 shows the composition of two additional samples having a fixed 7.5 wt % hexamine (“Novolac 1” as described above) that were also evaluated for ammonia emissions.

TABLE 1
Composition of samples being evaluated
for off-gassing of ammonia.

| | Resin 1 | Resin 1 with 10% | Resin 1 with 10% |
|---|---|---|---|
| | only | zeolite | limestone |
| Comp. Ex. | 10.02 g | 9.01 g | 9.01 g |
| Ex. 1: Zeolite | — | 1.00 g | — |
| Ex. 2: Limestone | — | — | 1.00 g |

TABLE 2
Composition of 10 g samples for tube
furnace ammonia testing confirmation.

| | | Novolac 1 |
|---|---|---|
| | Novolac 1 | with 7.5% Hexa |
| | with 7.5% Hexa | and 10% Zeolite |
| Novolac 1 | 9.25 g | 8.25 g |
| Hexamine | 0.75 g | 0.75 g |
| Zeolite (Clinoptilolite) | — | 1.00 g |

Table 3 below shows additional sample formulations of resin powders that were prepared and tested, according to the test procedures described below. For each sample, the components were ground together to form a homogenous powder using a minimill. The resulting free flowing powder was measured via Malvern Particle size analysis to yield particles that were greater than 98% less than or equal to 74 micron.

In all tables provided herein, the percentages are based on total weight unless otherwise specifically noted.

TABLE 3
Formulations of novolac base resin and other various components.
Components are shown as a percentage (%).
NOVOLAC SAMPLE #

| | | 2846-139- | 2846-139- | | | | | | | | |
|---|---|---|---|---|---|---|---|---|---|---|---|
| | 2854-1-1 | A1 | A2 | 2854-1-2 | 2854-1-3 | 2854-1-4 | 2854-1-5 | 2854-1-6 | 2854-6-1 | 2854-6-2 | 2854- [symbol] |
| Novolac 2 | 84.550 | 76.084 | 83.693 | 86.140 | — | — | — | — | — | — | — |
| Novolac 3 | — | — | — | — | 77.060 | 76.150 | — | — | 91.000 | 81.900 | 81.9 [symbol] |
| Novolac 4 | — | — | — | — | — | — | 77.060 | 76.150 | — | — | — |
| Hexamine | 8.700 | 7.837 | 8.620 | 8.860 | 7.940 | 7.850 | 7.940 | 7.850 | 9.000 | 8.100 | 8.1 [symbol] |
| Lime | 1.850 | 1.666 | 1.833 | — | — | — | — | — | — | — | — |
| Adipic Acid | — | — | — | — | — | 1.000 | — | 1.000 | — | — | — |
| Zinc Stearate | 4.900 | 4.413 | 4.854 | 4.990 | 5.000 | 5.000 | 5.000 | 5.000 | — | — | — |
| Clinoptilolite | — | 10.00 | 1.00 | — | 10.000 | 10.000 | 10.000 | 10.000 | — | 10.000 | — |
| Limestone | — | — | — | — | — | — | — | — | — | — | 10.0 [symbol] |

[symbol]

indicates data missing or illegible when filed

Novolac 1 was an oxalic acid catalyzed resin without a mold release.

Novolac 2 was a sulfuric acid catalyzed resin that was neutralized after the polymerization was complete. Novolac 2 contained the specified amount of mold release agent.

Novolac 3 was the same resin as Novolac 2 without the mold release agent.

Novolac 4 was a sulfuric acid catalyzed resin that was neutralized after the polymerization was complete. The mole ratio of formaldehyde to phenol of this resin yielded a cone and plate viscosity that was about 1200 cps at 175° C. with a free phenol content of about 4%.

### Reduction in Off-Gassing

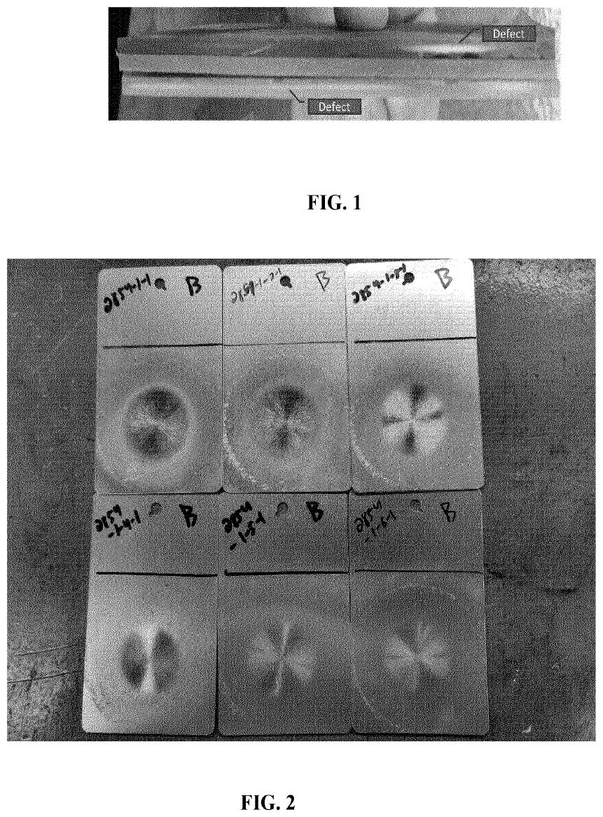

Off-gassing during curing was expected as it is known the curing agent, hexamine, decomposes releasing ammonia and formaldehyde, but when gasses are excessive or when the resin cures faster than gases can be released, this offgasing can cause defects that are exhibited as “foaming”, “bubbling”, or “puffiness”. Through the reduction of hexamine and the introduction of a selective microporous adsorbent material, clinoptilolite, there was considerably less off-gassing observed visually during the B-staging process to make the resin plaques (see procedure below) from the resin samples 2854-6-1, 2854-6-2, and 2854-6-3. When plaques were made with a B-staging interval of 2 minutes, the samples without the clinoptilolite exhibited defects due to trapped volatiles, as shown in FIG. 1 that shows a side view of three plaques that were produced. The top sample was 2854-6-1. The middle sample was 2854-6-2. The bottom sample was 2854-6-3. The top and bottom samples (i.e. the samples without the clinoptilolite) had imperfections due to trapped volatiles:

### Tube Furnace

A temperature profile consisting of a ramp to 164° C. at 10° C. per minute with a soak time of 30 minutes was used. The impinger was loaded with 150 mL dilute Methane Sulfonic Acid (MSA) with a constant nitrogen flow of approximately 50 mL/minute. A ceramic boat was loaded into a Lindberg Model 5035 mounted tube furnace and sealed off. After the temperature profile was complete the impinger was washed with 50 mL DI water. The impinger solution was then tested using the auto-titrator.

### Tube Furnace Sample Preparation

Samples were prepared by loading resin samples at 20 to 25% on 0.5 mm glass beads and placing them in 97×16×10 mm Fisherbrand® FB-963-C ceramic boats. The samples were mixed by loading the resin in excess with the glass beads in a small glass sample vial with tightly fitting plastic cap and shaking thoroughly to coat the beads. Boats were loaded with 1 to 1.2 grams of the shaken sample (resin+glass), where the loss of resin within the small mixing vessel was measured to obtain the amount of resin that was loaded to the boat.

### Auto-Titrator

A Metrohm Autotitrator Tiamo fitted with dual burettes (0.1N HCl and 0.1N NaOH) was used to titrate the sample, where the target endpoint was calculated to consume ˜10 mL of titrant. An Unitrode electrode was used to measure and determine the samples endpoints. SOP RD-016, RD-IR-384, RD-IR-385, RD-IR-391.

### Impinger Solution

An impinger solution was made using 70% MSA and water with a target concentration of 0.040% MSA. This concentration was chosen because 150 mL of solution is used in the Impinger and during titration this targets 30% capacity of the 20 mL burette. Table 4 below shows the results for testing the ammonia off-gassing impact of additives with Resin 1.

TABLE 4
ammonia off-gassing impact of additives

| | Resin 1 | Resin 1 with | Resin 2 with |
|---|---|---|---|
| | (control) | 10% Zeolite | 10% limestone |
| Percent ammonia | 0.451% ± | 0.355% ± | 0.405% ± |
| captured from | 0.035 | 0.009 | 0.039 |
| sample off-gassing | | | |
| Percent reduction in | — | 21.3% | 10.2% |
| ammonia | | | |
| Percent reduction in | — | 12.5% | 0.2% |
| ammonia | | | |
| (normalized for | | | |
| hexamine content) | | | |

The tube furnace results (Table 4) showed a significant decrease in ammonia off-gassing by the zeolite containing sample. The formulation that contained 10% zeolite showed a 21.3% (P-value: 0.0147) decrease in off-gassed ammonia relative to the control formulation. The formulation that contained 10% limestone showed a decrease of 10.2% (P-value: 0.156) relative to the control resin, which is also a significant result. These numbers reflect a significant improvement as it pertains to reduction of ammonia emissions during curing.

The data was normalized to the amount of resin and hexamine in each formulation to account for dilution effects by using the amount ammonia generated and dividing only by the amount of resin and hexamine in each sample (instead of the total sample weight). The normalized result more accurately reflects the amount of ammonia that is adsorbed by each additive. The formulation that contained 10% zeolite showed a 12.5% reduction in ammonia emissions versus the control resin, while the 10% limestone formulation showed a reduction of 0.20%. This result demonstrates a key benefit through the ability of the porous inorganic zeolite to adsorb a significant amount more of ammonia versus negligible ammonia adsorption on the nonporous inorganic filler.

A second set of tube furnace data was generated using Novolac 1 resin, in which the hexamine concentrations of both the control formulation and the zeolite containing material were kept constant. Table 5 below summarizes the resin formulations and results.

TABLE 5
Formulations and results for testing
ammonia off-gassing from Novolac 1.

| | | Novolac 1 and 10% |
|---|---|---|
| | Novolac 1 | Clinoptilolite |
| % Novolac 1 | 92.5 | 82.5 |
| % Hexamine | 7.5 | 7.5 |
| % Clinoptilolite Zeolite | 0.0 | 10.0 |
| % hexamine in final | 7.5% | 7.5% |
| formulation | | |
| Ammonia Results | | |
| Percent ammonia capture | 0.3557% ± 0.0196 | 0.3083% ± 0.0308 |
| from sample off-gassing | | |
| Percent reduction in | N/A | 13.3% |
| ammonia | | |

When the hexamine concentrations of the samples were equivalent, a 13.3% decrease in ammonia off-gassing was observed (P=0.02). This was comparable to the normalized reduction in off-gassing reported in Table 4 (12.5%). These values are indicative of the total amount of ammonia trapped by the clinoptilolite zeolite.

In summary, the presence of the clinoptilolite zeolite in the novolac-hexamine formulations provided a significant reduction, over 21%, of the ammonia that was produced.

### Reduction of Sticking and Staining

To test resin sticking and staining (wood flour composite): Wood flour was first dried in a forced draft oven at 125° C. for 3 h. After cooling, wood flour was combined with novolac resin powder in a can and placed on a roller mill with agitating balls for a minimum of 30 minutes to uniformly mix the wood flour with the formulated resin. Aluminum Q-plates were used on the hydraulic press, preheated to 180° C. At least 1 g of the resin/wood mixture was placed in the mold on the bottom plate and tapped until the mixture was even. The top plate was used to sandwich the resin/wood mixture. The plates were pressed together using a hydraulic press at 180° C. The press was opened and the top plate was lightly tapped to determine if it moved freely. If the plate moved freely, the plate sample was given a score of 0 for sticking. If the plates stuck together, the sample was given a score of 1 for sticking. The above process was repeated using the same plates 20 times to observe the stain remaining for visual evaluation and to provide a % score for sticking.

The sticking and staining studies were completed using a heated press and aluminum Q-plates. FIG. 2 shows the visual staining on the Q plates after pressing cycles. Top row: 2854-1-1, 2854-1-2-1, and 2854-1-3-1. Bottom row: 2854-1-4-1, 2854-1-5-1, and 2854-1-6-1. The “B” on each plate indicates the bottom plate used for the testing evaluation for staining. In this study, it was observed that the control had considerably more sticking and staining than any of the formulations that contained clinoptilolite zeolite. Table 6 below summarizes the staining test results. Sample 2854-1-5-1 provided the best results by minimizing both sticking and staining, which is advantageous in wood molding operations to reduce cleaning, downtime, and reduce scrap.

TABLE 6
Summary of sticking and staining studies

| | % of plates that stuck | Degree of staining left on |
|---|---|---|
| | together when removed | plates (0-none, 1-minor, 2- |
| Samples | from the press | moderate, 3-severe) |
| 2854-1-1 | 5% | 3 |
| 2854-1-2-1 | 0% | 2 |
| 2854-1-3-1 | 5% | 1 |
| 2854-1-4-1 | 0% | 1 |
| 2854-1-5-1 | 0% | 0 |
| 2854-1-6-1 | 0% | 1 |

### Reduction of Odor of Cured Article

The odor observations were made by four observers, one blind to the sample composition. The observations were made of the cured TGA samples (prior to grinding for TGA testing). The observation was made and is in line with the hypothesized effect of adsorption of ammonia into the porous clinoptilolite and is advantageous to composite production and application.

TABLE 7
Odor observations summary

| Samples | Observation |
|---|---|
| 2854-6-1 | Strong odor of ammonia |
| 2854-6-2 | Slight odor of ammonia |
| 2854-6-3 | Strong odor of ammonia but comparatively |
| | less than 2854-6-1 |

### Comparison of Resin Properties of Control to Modified Resin Formulation:

When changing the composition of the powdered resin formulations, the effect on the production process and the effect of the final physical properties was evaluated to determine any negative impact caused by the sorbents. Table 8 shows the rheological properties, as indicated by the glass plate flow (mm), of the tested powder formulations at 125° C.

TABLE 8
rheological properties.

| | Glass plate flow, |
|---|---|
| | 125° C., mm |
| 2846-139-Control | 38 |
| 2846-139-A1 | 37 |
| 2846-139-A2 | 38 |
| 2854-1-1 Control | 39 |
| 2854-1-3 | 37 |
| 2854-1-5 | 36 |
| 2854-6-1 | 47 |
| 2854-6-2 | 44 |
| 2854-6-3 | 45 |

The rheology was measured as a function of glass plate flow. The glass plate flow was measured using a forced air oven with an external crankshaft for raising and lowering shelf to 60°. A hand-held pill press was used to press 0.50 g of powder mixture into a pellet 12.5±3 mm in diameter and 4.8±0.2 mm thick. The resin pellet was then placed on the glass slide and on a wire mesh tray. The tray was placed into the oven at 125° C. for 3 minutes and then the shelf was lowered to 60° for another 15 minutes prior to returning the shelf to the original horizontal position and removing the wire mesh tray. The pellet and flow was measured by the rear of the pellet to the very end of the flow and this length includes the pellet diameter.

The glass plate flow is often impacted by inorganic components by shortening the flow. This applies to a minor shortening of flow (3 mm) when clinoptilolite zeolite was added at 10%. This can be a benefit in processing as the longer flow resins tend to show resin spots on the finished article.

### Comparison of Properties of Control to Modified Resins (Cured Resin Characteristics)

To produce resin only plaques: Three resin samples (2854-6-1, 2854 Jun. 2, and 2854 Jun. 3) were first B-staged (i.e. partially cured) for a period of 3 minutes on a foil lined pan in a vacuum oven set at 160° C. and 27″ of vacuum before opening the oven and rotating the sample 180° to ensure even B-staging and this process was repeated for another 3-minute period. The B-staged resin was then ground and 70 g was then spread evenly into a mold to obtain a “plaque” 6″×4″×1.5″ for testing. A large aluminum bar was settled into the top of the mold. The mold was then packed in a plastic heat resistant bag and 3 mm phenolic shims were placed on the edges of the mold to ensure proper thickness of the molded piece. The bag was then sealed with vacuum tape. The bagged mold was pressed on a preheated hydraulic press at 160° C. under 27″ of vacuum. The press force was ramped from 0 to 20 tons over the course of 10 minutes before being held at 20 tons for 50 minutes. This process yielded a plaque that was then cut into the designated sizes for DMA and 3 point bend testing, as reported in Tables 9 and 10 below.

TABLE 9
glass transition temperature (T_{g} °
C.) of the resin plaques as measured by DMA

| | T_{g} (° C.) |
|---|---|
| 2854-6-1 | 172.95 |
| 2854-6-2 | 172.14 |
| 2854-6-3 | 201.55 |

As seen in Table 9, the DMA results, specifically T_{g}, from the material containing clinoptilolite (2854-6-2) and control (2854-6-1) were nearly identical.

TABLE 10
Instron 3 Point Bend of resin plaques

| | Modulus (MPa) | Maximum Flexure Stress (MPa) |
|---|---|---|
| 2854-6-1 | 5913 | 73.33 |
| 2854-6-2 | 6794 | 74.07 |
| 2854-6-3 | 5924 | 98.83 |

Our results indicate increased modulus for the 3 point bend test using the clinoptilolite zeolite, at 10% loading in formulations 2854 Jun. 2. This is beneficial in composite formulations that require or would benefit from additional stiffness. The 3 point bend test was performed in accordance with ASTM D790-03.

### TGA Results

To produce samples for TGA testing: A 2 g sample of resin was placed in a 1″ diameter circular mold and pressed at 10 tons of force for 20 seconds to form a pellet. That pellet was then wrapped in foil and placed between two 12′″12″ steel plates. The steel plates with the pellet were then placed into an oven and metal weights were placed atop the sample. The oven was then heated to 175° C. and maintained at 175° C. for 5-18 hours. After this curing period the samples were removed and allowed to cool.

The cured resin was ground using a mini-mill in short 2-3 second bursts to obtain a rough grind. The sample was sieved through a #12 and a #20 sieve. The sample used for testing was retained on the #20 sieve. A 20-25 mg sample was loaded into the TGA instrument.

Thermogravimetric Analysis (TGA) was used to characterize the thermal decomposition of the materials. 20-25 mg of sample prepared for thermogravimetric analysis was loaded into a pre-tared aluminum pan in a TA Instruments Q50 thermogravimetric analyzer. The temperature was then ramped from ambient to 1000° C. under nitrogen atmosphere. The temperatures at weight losses of 5% and 10% were used to characterize the onset of degradation and the temperature of the peak of the % weight derivative curve was used as a peak degradation temperature. The peak degradation temperature is measured from the peak temperature of the derivative of the weight % curve. The % mass remaining at 1000° C. was characterized as the % char yield. The percent char at 1000° C. is a measure of the material's ability to create carbon with higher degrees of char at 1000° C. being generally accepted as providing beneficial properties for high temperature stability.

TABLE 11
TGA test results:

| | % Char Residue (@ 1000° | % Char Residue (@ 550° |
|---|---|---|
| | C.) in N₂ | C.) in air |
| 2854-6-1 | 55.14 | 0.00 |
| 2854-6-2 | 59.22 | 10.22 |
| 2854-6-3 | 62.13 | 4.02 |

The results from the thermogravimetric analysis (TGA) are aligned with typical measurements of phenolic based novolac resin along with inorganic components.

Application Testing: Incorporation of Clinoptilolite into a Wood Composite

To obtain wood composite bars: Wood flour was first dried in a forced draft oven at 125° C. for 3 h. After cooling, wood flour was combined with novolac resin powder in a can and placed on a roller mill with agitating balls for a minimum of 30 minutes. After mixing, 30 g of resin-wood powder mix was then poured into a mold that has been preheated to 180° C. with a preheated stainless steel pressing bar on the bottom. The powder was spread evenly into the mold and a preheated stainless steel top bar was seated into place just prior to the mold being placed into a preheated 180° C. hydraulic press. After pressing, the mold was removed and the metal pressing bars were removed to extract the final molded wood composite bar. This method produced wood composite bars for testing that were 1.125″ wide×4.0″ long and ˜0.5″ to 0.75″ in thickness.

TABLE 12
Instron 3 Point Bend of wood composite bar

| | | Modulus | Maximum Flexure Stress |
|---|---|---|---|
| Entry | | (MPa) | (MPa) |
| 1 | 2846-139-Control | 1377 | 50.3 |
| 2 | 2846-139-A1 | 1487 | 51.6 |
| 3 | 2846-139-A2 | 1639 | 55.0 |
| 4 | 2854-1-1 Control | 1010 | 39.0 |
| 5 | 2854-1-3 | 982 | 37.1 |
| 6 | 2854-1-5 | 960 | 37.9 |

The samples 2846-139-control, 2846-139-A1, 2846-A2 were prepared and pressed attempting to maintain constant pressure whereas the latter samples (2854-1-1 Control, 2854-1-3, 2854-1-5) were set to an initial pressure and the gap between the plates was kept constant for the duration of pressing. Data entries 4-6 showed minimum variation.

TABLE 13
Instron screw pull strength from wood composite bar:

| Entry | | Maximum load (lbf) |
|---|---|---|
| 1 | 2846-139-Control | 414 ± 34 |
| 2 | 2846-139-A1 | 316 ± 104 |
| 3 | 2846-139-A2 | 350 ± 53 |
| 4 | 2854-1-1 Control | 184 ± 25 |
| 5 | 2854-1-3 | 264 ± 17 |
| 6 | 2854-1-5 | 218 ± 39 |

Two different wood formulations were used for evaluation. The 2846-139-Control formulation outperformed the other two formulations but the amount of error in the measurement was high. To obtain a more realistic measurement, the latter formulations were used in the application formulation and the obtained measurements exhibited much less deviation per sample. The formulations containing 10% clinoptilolite zeolite performed better than or equal to the control under these more realistic conditions.

The water absorption of the bars was comparable to each other, a baseline measurement required by typical wood molding customers to be minimalized due to the application. The wood bar was prepared for the water absorption as described above for TGA testing. The prepared wood bars were cut crosswise in half with a bandsaw. The blocks were weighed prior to being submerged into room temperature deionized water for 24 hr. After the soak, each piece was removed from the water and gentle wiped with tissue paper to remove surface water and then weighted to obtain the percent water absorption. Table 14 summarizes these results.

TABLE 14
24 hr water absorption of wood composite bars:

| | wt % water absorption of wood |
|---|---|
| | composite bar, 24 hr soak |
| 2846-139-Control | — |
| 2846-139-A1 | — |
| 2846-139-A2 | — |
| 2854-1-1 Control | 8.50 |
| 2854-1-3 | 9.16 |
| 2854-1-5 | 8.46 |

In other specific embodiments, a cured resin composition containing the phenolic-aldehyde resin, hexamine and sorbent, as described herein, can include any combination of the following properties:
(a) a glass plate flow, as measured by the test procedure described herein, at 125° C. of 10 mm to 200 mm; the glass plate flow can also range from a low of about 10 mm, about 15 mm, or about 20 mm to high of about 140 mm, about 160 mm, or about 180 mm; the glass plate flow can also range from a low of about 10 mm, about 15 mm, or about 20 mm to high of about 60 mm, about 75 mm, or about 100 mm;
(b) a modulus of rupture (MOR), as measured by ASTM D790-03, of about 40 to about 150 MPa; the MOR can also range from a low of about 40, about 45, or about 50 to a high of about 100, about 130, or about 140 MPa;
(c) a maximum flexure stress (modulus of elasticity) as measured by ASTM D790, of about 5.0 to 8.0 GPa; the MOE can also range from a low of about 5.0, about 5.5, or about 6.0 to a high of about 7.0, about 7.5, or about 7.8 GPa; and/or
(d) a % Char residue at 1,000° C. in nitrogen of about 30 to about 75%, and at 550° C. in air of about 0 to about 30%, as measured by Thermogravimetric Analysis (TGA).

In other specific embodiments, a wood composite made from the cured phenolic-aldehyde resin, hexamine, and sorbent, as described herein, and mixed with a plurality of wood particles can include any combination of the following properties:
(a) water absorption, 24 hr soak, of about 5 to 45 wt %; the water absorption can also range from a low of about 5, about 10 or about 12 wt % to a high of about 30, about 40, or about 44 wt %;
(b) a modulus of elasticity (MOE) of about 800 to 2000 MPa; the MOE can also range from a low of about 850, about 950 or about 1,100 MPa to a high of about 1400, about 1600, or about 1950 MPa; and/or
(c) a maximum flexure stress of about 25 to about 70 MPa; maximum flexure stress can also range from a low of about 30, about 35 or about 40 to a high of about 55, about 60, or about 65 MPa.

In one or more other embodiments, methods for making a cured resin described herein are provided. One particular method includes

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention can be devised without departing from the basic scope thereof, and the scope thereof is determined by the claims that follow.

1. A binder composition comprising:
50-93 wt % of a phenolic-aldehyde novolac resin;
5-15 wt % hexamine;
2-30 wt % of at least one sorbent, based on the total weight of the resin, wherein a weight ratio of the at least one sorbent to the hexamine is about 1:0.5 to 1:8.62.

2. The binder composition of claim 1, wherein the phenolic-aldehyde novolac resin has a molar ratio of aldehyde to phenol of about 0.2:1 to about 0.7:1.

3. The binder composition of claim 1, wherein the phenolic-aldehyde novolac resin has a molar ratio of aldehyde to phenol of about 0.5:1 to about 0.95:1.

4. The binder composition of claim 1, wherein the binder composition is a powder.

5. The binder composition of claim 1, wherein the sorbent is a porous inorganic material with pore sizes of 2 Å to 20 Å that are configured to trap ammonia gas.

6. The binder composition of claim 1, wherein the sorbent is a clinoptilolite zeolite.

7. The binder composition of claim 1, wherein the weight ratio of the at least one sorbent to the hexamine is about 1:0.5.

8. A cured resin composition, comprising:
50-93 wt % of a phenolic-aldehyde novolac resin;
5-15 wt % hexamine; and
2-30 wt % of at least one sorbent, based on the total weight of the resin composition, wherein the cured resin composition has a glass plate flow at 125° C. of 10 mm to 200 mm; a modulus of rupture (MOR), as measured by ASTM D790-03, of about 40 to about 150 MPa; a maximum flexure stress (modulus of elasticity) of about 5.0 to 8.0 GPa; and a % Char residue at 1,000° C. in nitrogen of about 30 to about 75%, as measured by Thermogravimetric Analysis (TGA).

9. The cured resin composition of claim 8, wherein the sorbent is a porous inorganic material with pore sizes of 2 Å to 20 Å and a weight ratio of the sorbent to the hexamine is about 1:0.5.

10. The cured resin composition of claim 9, wherein the sorbent is a clinoptilolite zeolite.

11. The cured resin composition of claim 9, wherein the sorbent is a clinoptilolite zeolite and is 10 wt % of the total weight of the binder composition.

12. The cured resin composition of claim 8, wherein the resin composition is only partially cured at a temperature of about 70° C. to about 250° C. for about 5 seconds to about 150 seconds.

13. A wood composite made from the cured binder composition of claim 8.

14. The wood composite of claim 13, wherein the wood composite has a water absorption, 24 hr soak, of about 5 to 45 wt %.

15. The wood composite of claim 13, wherein the wood composite has a modulus of elasticity (MOE) of about 800 to 2000 MPa and a maximum flexure stress of about 25 to about 70 MPa.

16. The binder composition of claim 1, wherein the sorbent is a zeolite, molecular sieves or silica gel.

17. The binder composition of claim 1, wherein the sorbent is selected from a clinoptilolite, heulandite, stilbite, natrolite, analcime, chabazite, gismondine, phillipsite, levynite, mordenite, andersite, erionite, scolecite, ferrierite, laumonite, Linde Type A (LTA), Linde Types X and Y, Silicalite-1, ZSM-5, Linde Type B, and MCM-41.

18. The cured resin composition of claim 8, wherein a weight ratio of the at least one sorbent to the hexamine is about 1:0.5 to 1:8.62.

19. The cured resin composition of claim 8, wherein a weight ratio of the at least one sorbent to the hexamine is about 1:0.5.

20. The cured resin composition of claim 8, wherein the sorbent is selected from a clinoptilolite, heulandite, stilbite, natrolite, analcime, chabazite, gismondine, phillipsite, levynite, mordenite, andersite, erionite, scolecite, ferrierite, laumonite, Linde Type A (LTA), Linde Types X and Y, Silicalite-1, ZSM-5, Linde Type B, and MCM-41.
